(19) United States
(12) Patent Application Publication
(10) Pub. No.: US 2023/0005206 A1
(43) Pub. Date: Jan. 5, 2023

(54) METHOD AND SYSTEM FOR REPRESENTING AVATAR FOLLOWING MOTION OF USER IN VIRTUAL SPACE

(71) Applicant: LINE Plus Corporation, Seongnam-si (KR)

(72) Inventors: Geum Yong YOO, Seongnam-si (KR); Snow KWON, Seongnam-si (KR); Hunkwang HA, Seongnam-si (KR); Ohik KWON, Seongnam-si (KR); Jungnam GWOCK, Seongnam-si (KR)

(73) Assignee: LINE Plus Corporation, Seongnam-si (KR)

(21) Appl. No.: 17/943,668

(22) Filed: Sep. 13, 2022

Related U.S. Application Data
(63) Continuation of application No. PCT/KR2020/003887, filed on Mar. 20, 2020.

(51) Int. Cl. G06T 13/40; G06T 19/00; G06T 7/246; G06V 40/16; G06V 40/20; H04N 7/14; H04L 12/18

(52) U.S. Cl. CPC G06T 13/40; G06T 19/006; G06T 7/246; G06V 40/176; G06V 40/20; H04N 7/147; H04L 12/1895

(57) ABSTRACT

A non-transitory computer-readable recording medium storing instructions that, when executed by a processor, cause the processor to set a communication session in which a plurality of users participate through a server, generate data for a virtual space, share motion data related to motions of the plurality of users through the communication session, generate a video in which avatars following the motions of the plurality of users are represented in the virtual space, based on the motion data, and share the generated video with the plurality of users through the communication session.

### CROSS-REFERENCE TO RELATED APPLICATION

This is a bypass continuation of International Application No. PCT/KR2020/003887, filed Mar. 20, 2020, in the Korean Intellectual Property Receiving Office, the contents of which are incorporated herein by reference in its entirety.

### BACKGROUND

### 1. Field

The present disclosure relates generally to a method and system for representing an avatar following a motion of a user in a virtual space.

### 2. Description of Related Art

An avatar refers to a character that represents an individual online and is gaining attention as an expression tool of a user for providing a realistic virtual environment through constant interaction with others in the virtual world. Such an avatar is being used in various fields, such as an advertisement, film production, game design, and teleconference.

However, the related arts only provide an avatar that simply performs a motion selected by a user from among preset motions (e.g., movements and/or facial expressions of the avatar) on a service in which a plurality of participants are present and do not express avatars that follow motions of participants in real time in the service.

### SUMMARY

Provided is an avatar representation method and system that may represent avatars of participants following motions of the participants including an owner on a virtual space and may share the virtual space with the participants in real time.

According to an aspect of the disclosure, a non-transitory computer-readable recording medium may store instructions that, when executed by a processor, cause the processor to set a communication session in which a plurality of users participate through a server, generate data for a virtual space, share motion data related to motions of the plurality of users through the communication session, generate a video in which avatars following the motions of the plurality of users are represented in the virtual space, based on the motion data, and share the generated video with the plurality of users through the communication session.

The instructions, when executed, may cause the processor to generate the data for the virtual space by capturing an image input through a camera, and the instructions, when executed, may cause the processor to generate the video by generating the video by representing the avatars following the motions of the plurality of users on the captured image.

The instructions, when executed, may cause the processor to share of the motion data related to the motions of the plurality of users by receiving the motion data in real time through the communication session based on a real-time transmission protocol, and the instructions, when executed, may cause the processor to share the generated video with the plurality of users by transmitting the generated video to terminals of the plurality of users in real time through the communication session based on the real-time transmission protocol.

The server may be configured to route data transmitted between terminals of the plurality of users through the communication session.

The instructions, when executed, may further cause the processor to share voices of the plurality of users through the communication session or another communication session set separate from the communication session.

The motion data may include data related to at least one of poses and facial expressions of the plurality of users.

A pose of each of the avatars may be configured to include a plurality of bones, and the motion data may include an index of each of the plurality of bones, rotation information of each of the plurality of bones in a three-dimensional (3D) space, position information of each of the plurality of bones in the virtual space, and information on a current tracking state of each of the plurality of bones.

The motion data may include coefficient values calculated for a plurality of points predefined for a face of a person based on a face blendshape scheme.

According to an aspect of the disclosure, an avatar representation method may include setting a communication session in which a plurality of users participate through a server, generating data for a virtual space, sharing motion data related to motions of the plurality of users through the communication session, generating a video in which avatars following the motions of the plurality of users are represented in the virtual space, based on the motion data, and sharing the generated video with the plurality of users through the communication session.

According to an aspect of the disclosure, an avatar representation method may include setting a communication session in which a plurality of users participate through a server, receiving data for a virtual space from a terminal of a user among the plurality of users that is an owner of the virtual space, receiving motion data related to motions of the plurality of users from terminals of the plurality of users through the communication session, generating a video in which avatars following the motions of the plurality of users are represented in the virtual space, based on the motion data, and transmitting the generated video to each of the terminals of the plurality of users through the communication session.

The receiving of the data for the virtual space may include receiving, as the data for the virtual space, an image captured through a camera of the terminal of the user that is the owner of the virtual space, and the generating of the video may include generating the video by representing the avatars following the motions of the plurality of users on the received image.

The receiving of the motion data may include receiving the motion data from the terminals of the plurality of users in real time through the communication session based on a real-time transmission protocol, and the transmitting of the generated video may include transmitting the video generated to the terminals of the plurality of users in real time through the communication session based on the real-time transmission protocol.

The method may include routing data transmission between the terminals of the plurality of users through the communication session.

The method may include mixing voices received from the plurality of users through the communication session or another communication session set separate from the communication session, and providing the mixed voice to the plurality of users.

The motion data may include data related to at least one of poses and facial expressions of the plurality of users.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating an example of a network environment according to an example embodiment;

FIG. 2 is a diagram illustrating an example of a computer device according to an example embodiment;

FIGS. 3, 4, 5 and 6 are diagrams of examples of an avatar representation method according to an example embodiment;

FIG. 7 is a diagram of an example of an avatar representation method according to an example embodiment;

FIG. 8 is a diagram of an example of a bone structure of an avatar according to an example embodiment;

FIG. 9 is a diagram of an example of selecting participants according to an example embodiment;

FIG. 10 is a diagram of an example of displaying a mixed video according to an example embodiment;

FIG. 11 is a flowchart illustrating an example of an avatar representation method of a client according to an example embodiment; and

FIG. 12 is a flowchart illustrating an example of an avatar representation method of a server according to an example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

Units and/or devices according to one or more example embodiments may be implemented using hardware and/or a combination of hardware and software. For example, hardware devices may be implemented using processing circuitry such as, but not limited to, a processor, central processing unit (CPU), a controller, an arithmetic logic unit (ALU), a digital signal processor, a microcomputer, a field programmable gate array (FPGA), a system-on-chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), CPU, a controller, an ALU, a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a universal serial bus (USB) flash drive, a memory stick, a Blu-ray/digital versatile disc (DVD)/compact disc (CD)-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device. However, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

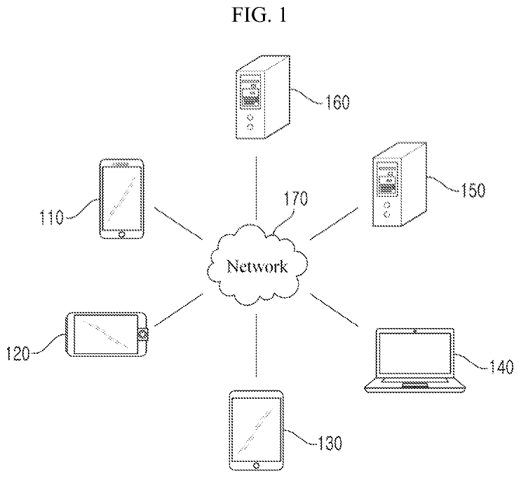

An avatar representation system according to the example embodiments may include a computer device that implements at least one client and a computer device that implements at least one server, and an avatar representation method according to the example embodiments may be performed through at least one computer device included in the avatar representation system. Here, a computer program according to an example embodiment may be installed and executed on the computer device. The computer device may perform the avatar representation method according to the example embodiments under control of the executed computer program. The computer program may be stored in a non-transitory computer-readable record medium to computer-implement the avatar representation method in conjunction with the computer program. 100521 FIG. 1 illustrates an example of a network environment according to an example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto. Also, the network environment of FIG. 1 is provided as an example only among environments applicable to the example embodiments. The environments applicable to the example embodiments are not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service to the plurality of electronic devices 110, 120, 130, and 140 connected over the network 170. For example, the service may include an instant messaging service, a game service, a group call service (or a voice conference service), a messaging service, a mail service, a social network service, a map service, a translation service, a financial service, a payment service, a search service, a content providing service, and the like.

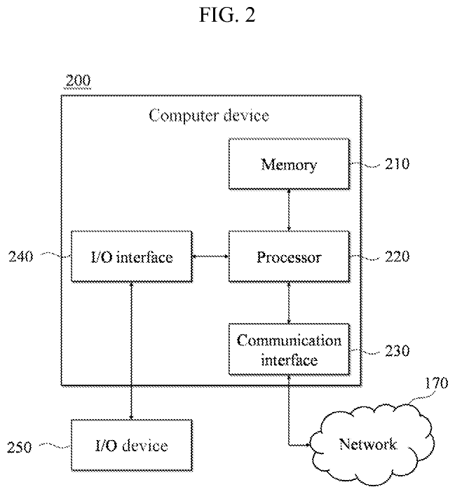

FIG. 2 is a block diagram illustrating an example of a computer device according to an example embodiment. Each of the plurality of electronic devices 110, 120, 130, and 140 or each of the servers 150 and 160 may be implemented by the computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a RAM, a ROM, and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another device, for example, the aforementioned storage devices. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. At least one of the I/O device 250 may be configured as a single apparatus with the computer device 200. For example, a touchscreen, a microphone, a speaker, etc., of a smartphone, may be included in the computer device 200.

According to other example embodiments, the computer device 200 may include a number of components greater than or less than a number of components shown in FIG. 2. For example, the computer device 200 may include at least a portion of the I/O device 250, or may further include other components, for example, a transceiver, a database (DB).

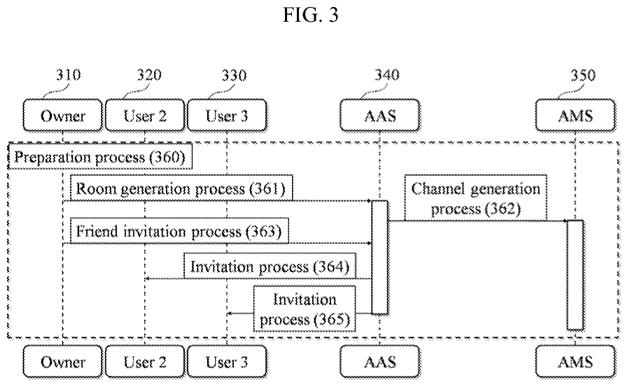

FIGS. 3, 4, 5 and 6 are diagrams of examples of an avatar representation method according to at least one example embodiment. FIGS. 3 to 6 illustrate an owner 310, a second user 320, a third user 330, an avatar API server (AAS) 340, and an avatar media server (AMS) 350. The AAS 340 and the AMS 350 may be included in a single server, or may be distributed in a plurality of servers.

Here, each of the owner 310, the second user 320, and the third user 330 may be a terminal as a physical device substantially used by a corresponding user to use a service. This terminal may be implemented in a form of the computer device 200 of FIG. 2. For example, the owner 310 may be implemented in a form of the computer device 200 of FIG. 2 and may perform an operation for performing the avatar representation method by way of the processor 220 included in the computer device 200 under control of an application installed and running on the computer device 200, to use a specific service. The owner 310, the second user 320, and the third user 330 that provide the specific service through this application may be clients of the specific service.

Also, each of the AAS 340 and the AMS 350 may be a software module that is implemented in individual physical devices or implemented in a single physical device. The physical device in which the AAS 340 and/or the AMS 350 are implemented may also be implemented in a form of the computer device 200 of FIG. 2. The AAS 340 and the AMS 350 may be at least a portion of a server system for providing the specific service.

Referring to FIG. 3, a preparation process 360 may include a room generation process 361, a channel generation process 362, a friend invitation process 363, and invitation processes 364 and 365.

In the room generation process 361, the owner 310 may request the AAS 340 to generate a room. For example, the room may represent a chatroom for conducting a conversation between participants based on text, audio, and/or video.

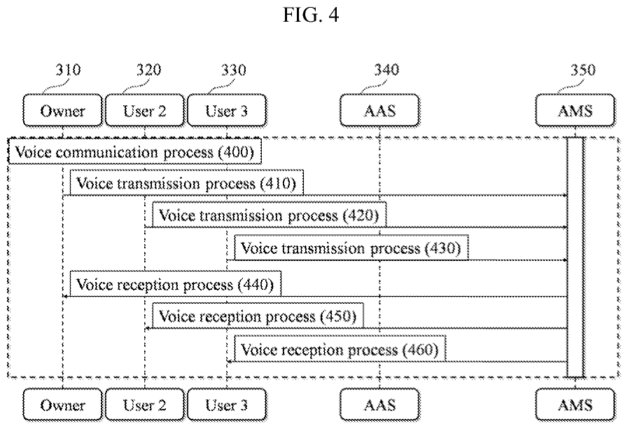

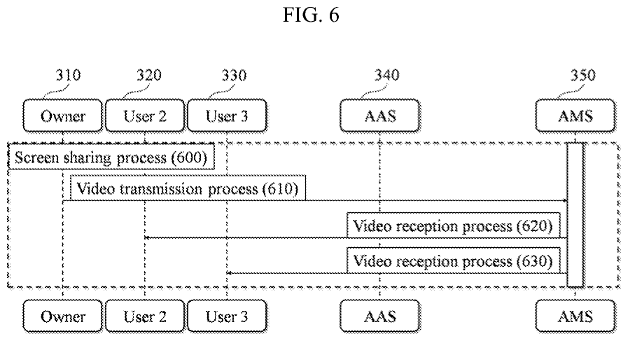

In the channel generation process 362, the AAS 340 may request the AMS 350 to generate a media channel in response to a room generation request from the owner 310. If the room is a logical channel for the participants, the media channel may refer to an actual channel through which participant data is delivered. Here, the generated media channel may be maintained for the following voice communication process 400 of FIG. 4 and screen sharing process 600 of FIG. 6.

In the friend invitation process 363, the owner 310 may request the AAS 340 to invite friends to the generated room. Here, the friends may represent other users having a personal relationship with the owner 310 in the corresponding service. The example embodiment describes an example in which the owner 310 invites the second user 320 and the third user 330. For example, the owner 310 may request the AAS 340 to invite desired friends by selecting friends that the owner 310 desires to invite from a list of friends.

In the invitation processes 364 and 365, the AAS 340 may invite the second user 320 and the third user 330 selected as the friends of the owner 310 to the room in response to the request from the owner 310.

As described above, the preparation process 360 may be an example of a process of setting a communication session between participants of a service using the avatar representation method according to example embodiments. Although the example embodiment of FIG. 3 describes an example of setting a chatroom, the communication session is not limited to the chatroom. Also, although three participants in the communication session are present in the preparation process 360 of FIG. 3, it will be easily understood that a number of participants in the communication session may be variously set based on a number of friends invited by the owner 310. The number of participants may be variously set by the owner 310 within a limited number of persons set in the service.

Referring to FIG. 4, the voice communication process 400 may include voice transmission processes 410, 420, and 430 and voice reception processes 440, 450, and 460. This voice communication process 400 may be optionally used to enable a voice conversation between the participants. That is, the voice communication process 400 may be omitted from a service that does not provide the voice conversation between the participants.

In the voice transmission processes 410, 420, and 430, the owner 310, the second user 320, and the third user 330 may transmit their own voice to the AMS 350. Here, voice transmission may be premised on a case in which the voices are recognized from the owner 310, the second user 320, and the third user 330. For example, unless the voice of the second user 320 is recognized, the voice transmission process 420 from the second user 320 the AMS 350 may be omitted.

In the voice reception processes 440, 450, and 460, each of the owner 310, the second user 320, and the third user 330 may receive the mixed voice from the AMS 350. Here, the mixed voice may refer to an audio in which remaining voices excluding his or her own voice are mixed. For example, it is assumed that voices are simultaneously transmitted from the owner 310, the second user 320, and the third user 330 to the AMS 350. In this case, the AMS 350 may transmit, to the third user 330, an audio in which the voices of the owner 310 and the second user 320 are mixed, may transmit, to the second user 320, an audio in which the voices of the owner 310 and the third user 330 are mixed, and may transmit, to the owner 310, an audio in which the voices of the second user 320 and the third user 330 are mixed. As another example, it is assumed that the voices are simultaneously transmitted from the owner 310 and the third user 330 to the AMS 350. In this case, the AMS 350 may transmit, to the second user 320, an audio in which the voices of the owner 310 and the third user 330 are mixed, and may transmit, to the third user 330, an audio in which the voice of the owner 310 is included, and may transmit, to the owner 310, an audio in which the voice of the third user 330 is included. As another example, when only the voice of the owner 310 is transmitted to the AMS 350, the AMS 350 may transmit an audio in which the voice of the owner 310 is included to each of the second user 320 and the third user 330.

As described above, the voice communication process 400 may be optionally used to enable the voice conversation between the participants. Also, the following avatar sharing process 500 and screen sharing process 600 may be performed in parallel with the voice communication process 400.

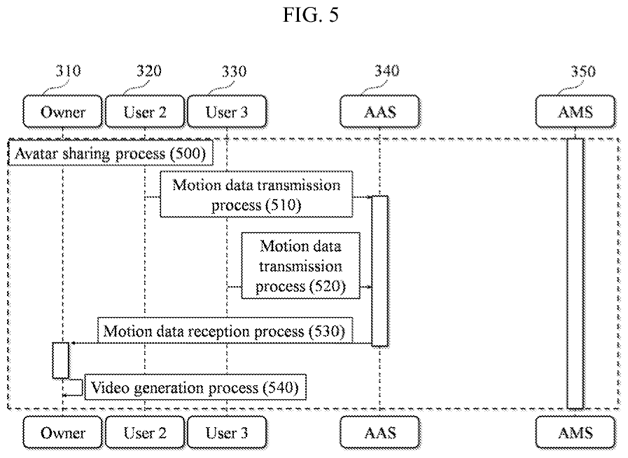

Referring to FIG. 5, the avatar sharing process 500 may include motion data transmission processes 510 and 520, a motion data reception process 530, and a video generation process 540.

In the motion data transmission processes 510 and 520, the second user 320 and the third user 330 may transmit their motion data to the AAS 340. The motion data may be acquired from an image captured through a camera in each of the second user 320 and the third user 330. The motion data may include data related to at least one of a pose and a facial expression of a corresponding user. As another example embodiment, the motion data may include data of a motion selected by the corresponding user from among a plurality of preset motions. As still another example embodiment, the motion data may be extracted from an image or a video prestored in a terminal of a corresponding user or prestored on the web.

In the motion data reception process 530, the owner 310 may receive the motion data of the second user 320 and the third user 330 from the AAS 340. That is, the motion data from the second user 320 and the third user 330 may be delivered to the owner 310 through the AAS 340.

In the video generation process 540, the owner 310 may represent avatars of the owner 310, the second user 320, and the third user 330 following the motions of the owner 310, the second user 320, and the third user 330 in the virtual space of the owner 310, based on the motion data of the second user 320 and the third user 330 and the motion data of the owner 310 and may generate a video for the virtual space in which such avatars are represented. Here, the virtual space of the owner 310 may include, for example, an augmented reality (AR) space in an image captured through the camera of the virtual space. That is, in the AR space captured through the camera by the owner 310, avatars of the second user 320 and the third user 330 as well as the avatar of the owner 310 may be displayed and motions of the owner 310, the second user 320, and the third user 330 may be applied to the avatars in real time. In another example embodiment, the virtual space of the owner 310 may be a virtual space selected by the owner 310 from among pre-generated virtual spaces. In still another example embodiment, the virtual space of the owner 310 may be extracted from an image or a video prestored in the terminal of the owner 310 or prestored on the web.

Referring to FIG. 6, the screen sharing process 600 may include a video transmission process 610 and video reception processes 620 and 630.

In the video transmission process 610, the owner 310 may transmit, to the AMS 350, a video in which avatars of participants are displayed on a virtual space of the owner 310. Here, the mixed video may correspond to the video generated in the video generation process 540 of FIG. 5.

In the video reception processes 620 and 630, the second user 320 and the third user 330 may receive the mixed video from the AMS 350. That is, the video in which the avatars of the participants in the room are displayed on the virtual space of the owner 310 and, at the same time, motions of the participants are applied to the corresponding avatars in real time may be shared between the participants of the room in real time. To this end, in the voice communication process 400, the avatar sharing process 500, and the screen sharing process 600, communication between the participants and the AMS 350 may be performed using a real-time transmission protocol. For example, the voice communication process 400 may be conducted using a real-time transport protocol (RTP) and the avatar sharing process 500 and the screen sharing process 600 may be performed using a real-time streaming protocol (RTSP).

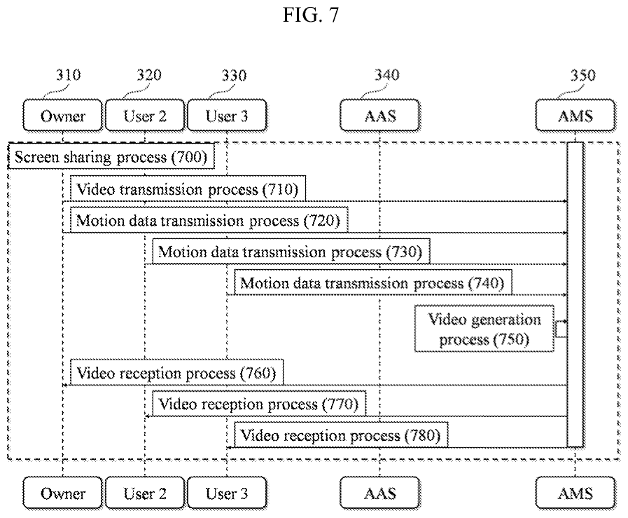

FIG. 7 is a diagram of an example of an avatar representation method according to at least one example embodiment. The avatar representation method of FIG. 7 may include the preparation process 360 and the voice communication process 400 of FIG. 4, and may also include a screen sharing process 700 in which the avatar sharing process 500 and the screen sharing process 600 are combined. FIG. 7 illustrates only the screen sharing process 700.

The screen sharing process 700 may include a video transmission process 710, motion data transmission processes 720, 730, and 740, a video generation process 750, and video reception processes 760, 770, and 780.

In the video transmission process 710, the owner 310 may transmit the video to the AMS 350. Here, the transmitted video may be a video that represents a virtual space of the owner 310. For example, when the virtual space of the owner 310 is a video captured through a camera included in a terminal of the owner 310, the corresponding video may be transmitted to the AMS 350.

In motion data transmission processes 720, 730, and 740, each of the owner 310, the second user 320, and the third user 330 may transmit the motion data to the AMS 350. As described above, the motion data may include data related to at least one of a pose and a facial expression of a corresponding user. As another example embodiment, the motion data may include data of a motion selected by the corresponding user from among a plurality of preset motions. As still another example embodiment, the motion data may be extracted from an image or a video prestored in the terminal of the corresponding user or prestored on the web.

In the video generation process 750, the AMS 350 may generate a mixed video by mixing avatars that follow motions of the owner 310, the second user 320, and the third user 330 based on the motion data of each of the owner 310, the second user 320, and the third user 330 received by the AMS 350 in the motion data transmission processes 720, 730, and 740 in the virtual space of the owner 310 received by the AMS 350 through the video transmission process 710.

In the video reception processes 760, 770, and 780, the owner 310, the second user 320, and the third user 330 may receive, from the AMS 350, the mixed video that is generated in the video generation process 750. Therefore, avatars of the participants in the room may be displayed on the virtual space of the owner 310 and the video in which the avatars follow motions of the corresponding participants may be shared between the participants in real time.

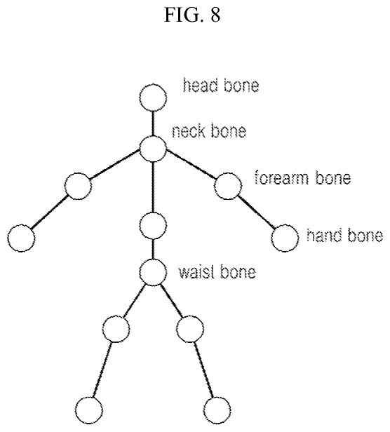

FIG. 8 is a diagram of an example of a bone structure of an avatar according to an example embodiment. Table 1 shows an example of a data structure for expressing a pose as motion data. From perspective of a single frame of video in which an avatar is represented, only a pose of the avatar may be represented in the corresponding frame and a motion of the avatar may be implemented by poses of the avatar connected through connection such frames.

TABLE 1

| Key | Description |
|---|---|
| Bone index | A number of a bone that constitutes an avatar |
| Rotation information | Quaternions x, y, z, and w that represent |
| (qx, qy, qz, qw) | rotation information in a 3D space |
| Position information | Position vectors x, y, and z that represent |
| (tx, ty, tz) | position information in a virtual space |
| Tracking state | A current tracking state of a bone (having |
| | paused, stopped, and tracking values) |
| Number of bones | A number of bones that constitute an avatar |
| fps | A number of pieces of motion data to be |
| | transmitted per second |

As described above, a pose of an avatar may be configured by including a plurality of bones, and the motion data may include an index of each of the plurality of bones, rotation information of each of the plurality of bones in a 3D space, position information of each of the plurality of bones in the virtual space, and information on a current tracking state of each of the plurality of bones.

For example, with the assumption that motion data is transmitted at 10 fps, the motion data may be transmitted ten times per second. Here, each piece of motion data may include a bone index, rotation information of each bone, position information of each bone, and information on a tracking state of each bone. In the case of an avatar that includes 11 bones as in the example embodiment of FIG. 8, the motion data transmitted once may include 11 bone index, 11 pieces of rotation information, 11 pieces of position information, and 11 tracking states.

Also, as described above, the motion data may further include data related to facial expressions of avatars as well as poses of users. To this end, the motion data may include coefficient values calculated for a plurality of points predefined for a face of a person based on a face blendshape scheme. For example, 52 facial points may be defined as the plurality of points and each of the coefficient values may be calculated to have a value between 0.0 and 1.0. For example, for a point “eye,” a value of 0.0 may correspond to a state in which eyes are closed and a value of 1.0 may correspond to a state in which the eyes are open as wide as possible. For motion data related to this facial expression, a number of transmissions may be determined based on set fps.

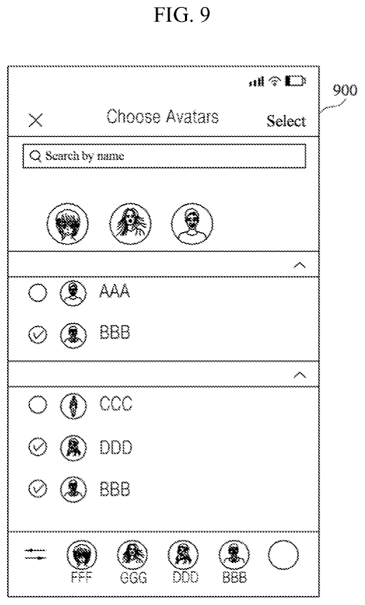

FIG. 9 is a diagram of an example of selecting participants according to at least one example embodiment. An avatar selection screen 900 may represent an example of an interface screen displayed on a display of the terminal of the owner 310 such that the owner 310 may select participants (avatars of the participants) to be invited to a room. An application installed and running on the terminal of the owner 310 may provide a list of friends of the owner 310, and friends selected by the owner 310 from the list of friends may be selected as participants to be invited to the room.

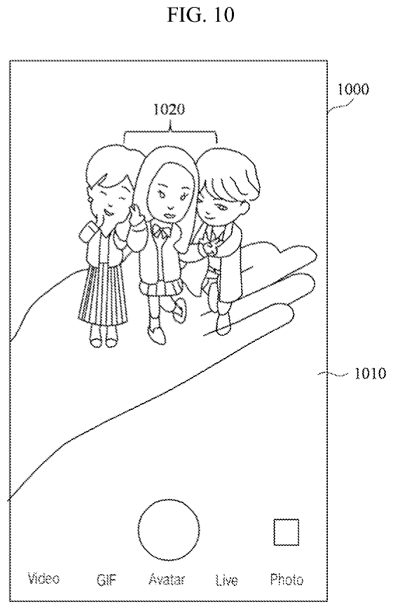

FIG. 10 is a diagram of an example of displaying a mixed video according to at least one example embodiment. A video display screen 1000 may be an example of a video sharing screen displayed on a terminal display of the owner 310 or terminal displays of other participants. For example, the video display screen 1000 represents an example in which avatars 1020 of three participants including the owner 310 are represented on a virtual space 1010 acquired through a video captured through a camera included in the terminal of the owner 310. The example displayed on the video display screen 1000 may be a single frame of the corresponding video. When a plurality of frames is sequentially displayed according to the aforementioned avatar representation method, it may be easily understood that motions of the participants may be applied to the avatars in real time.

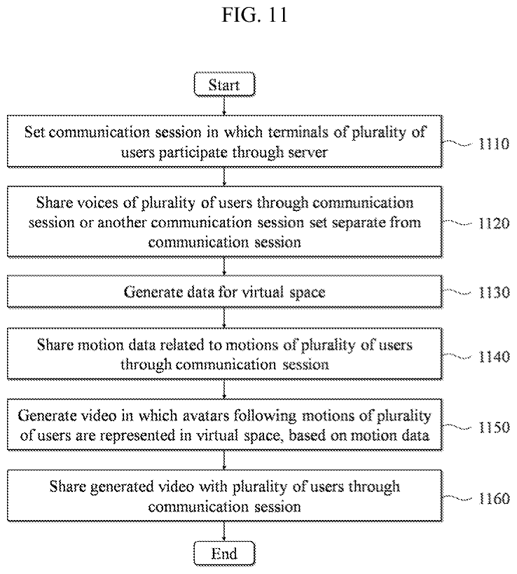

FIG. 11 is a flowchart illustrating an example of an avatar representation method of a client according to an example embodiment. The avatar representation method according to the example embodiment may be performed by the computer device 200 that implements a client device. Here, the client device may be an entity that uses a service from a server under control of a client program installed on the client device. Also, the client program may correspond to an application for the aforementioned service. Here, the processor 220 of the computer device 200 may be implemented to execute a control instruction according to a code of at least one computer program or a code of an OS included in the memory 210. Here, the processor 220 may control the computer device 200 to perform operations 1110 to 1160 included in the method of FIG. 11 in response to the control instruction provided from the code stored in the computer device 200.

In operation 1110, the computer device 200 may set a communication session in which terminals of a plurality of users participate through a server. An example of setting the communication session is described above through the preparation process 360 of FIG. 3. Here, data transmitted between the terminals of the plurality of users may be routed at the server through the communication session.

In operation 1120, the computer device 200 may share voices of the plurality of users through the communication session or another communication session set separate from the communication session. For example, an example of sharing the voices of the plurality of users is described above through the voice communication process 400 of FIG. 4. Operation 1120 may be performed after operation 1110 and may be performed in parallel with the following operations 1130 to 1160. Depending on example embodiments, operation 1120 may be omitted.

In operation 1130, the computer device 200 may generate data for a virtual space. For example, the computer device 200 may generate data for the virtual space by capturing an image input through a camera included in the computer device 200. As another example, the computer device 200 may generate data for the virtual space by selecting a specific virtual space from among pre-generated virtual spaces. As still another example, the computer device 200 may extract data for the virtual space from an image or a video prestored in a local storage of the computer device 200 or prestored on the web.

In operation 1140, the computer device 200 may share motion data related to motions of the plurality of users through the communication session. An example of sharing the motion data is described above through the avatar sharing process 500 of FIG. 5. For example, the motion data may include data related to at least one of poses and facial expressions of the plurality of users. In detail, for example, a pose of each of the avatars may be configured by including a plurality of bones. In this case, the motion data may include an index of each of the plurality of bones, rotation information of each of the plurality of bones in a three-dimensional (3D) space, position information of each of the plurality of bones in the virtual space, and information on a current tracking state of each of the plurality of bones. As another example, the motion data may include coefficient values calculated for a plurality of points predefined for a face of a person based on a face blendshape scheme.

In operation 1150, the computer device 200 may generate a video in which avatars following the motions of the plurality of users are represented in the virtual space, based on the motion data. An example of generating the video in which the avatars are represented in the virtual space is described above through the avatar sharing process 500 of FIG. 5. For example, the computer device 200 may generate the video by representing the avatars that follow motions of the plurality of users on an image captured through the camera.

In operation 1160, the computer device 200 may share the generated video with the plurality of users through the communication session. An example of sharing the generated video is described above through the screen sharing process 600 of FIG. 6. For example, in operation 1140, the computer device 200 may receive the motion data in real time through the communication session using a real-time transmission protocol. In this case, in operation 1160, the computer device 200 may transmit the video generated based on the motion data to the terminals of the plurality of users in real time through the communication session using the real-time transmission protocol. Through this, the participants of the communication session may share the virtual space in which the avatars to which the motions of the participants of the communication session are applied in real time are represented.

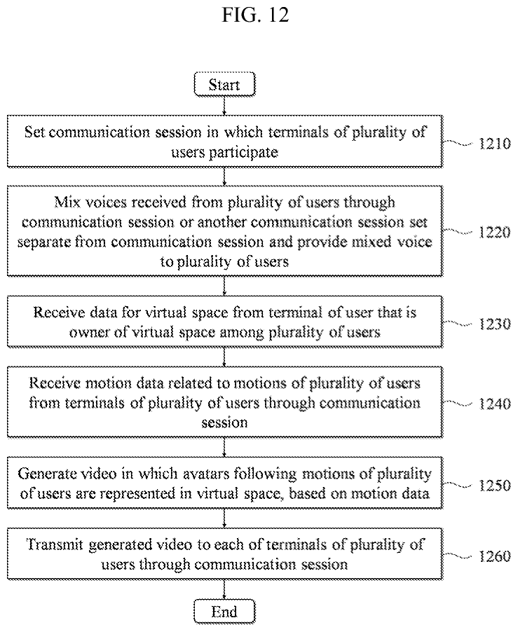

FIG. 12 is a flowchart illustrating an example of an avatar representation method of a server according to an example embodiment. The avatar representation method according to the example embodiment may be performed by the computer device 200 that implements the server. Here, the server may be an entity that provides a service to a plurality of client devices each in which a client program is installed. For example, the server may include the aforementioned AAS 340 and AMS 350. Also, the client program may correspond to an application for the aforementioned service. Here, the processor 220 of the computer device 200 may be implemented to execute a control instruction according to a code of at least one computer program or a code of an OS included in the memory 210. Here, the processor 220 may control the computer device 200 to perform operations 1210 to 1260 included in the method of FIG. 12 according to the control instruction provided from the code stored in the computer device 200.

In operation 1210, the computer device 200 may set a communication session in which terminals of a plurality of users participate. An example of setting the communication session is described above through the preparation process 360 of FIG. 3. To this end, the computer device 200 may route a data transmission between the terminals of the plurality of users through the communication session.

In operation 1220, the computer device 200 may mix voices received from the plurality of users through the communication session or another communication session set separate from the communication session and may provide the mixed voice to the plurality of users. For example, an example of mixing, by the AMS 350, and providing the voices of the plurality of users is described above through the voice communication process 400 of FIG. 4. Operation 1220 may be performed after operation 1210, and may be performed in parallel with the following operations 1230 to 1260. Depending on example embodiments, operation 1220 may be omitted.

In operation 1230, the computer device 200 may receive data for a virtual space from a terminal of a user that is an owner of the virtual space among the plurality of users. For example, the computer device 200 may receive an image captured through a camera included in the terminal of the user that is the owner of the virtual space, as data for the virtual space. As described above, the data for the virtual space may be generated through the existing image or video instead of using the image captured through the camera.

In operation 1240, the computer device 200 may receive motion data related to motions of the plurality of users from the terminals of the plurality of users through the communication session. For example, the motion data may include data related to at least one of poses and facial expressions of the plurality of users. In detail, for example, a pose of each avatar may be configured by including a plurality of bones. In this case, the motion data may include an index of each of the plurality of bones, rotation information of each of the plurality of bones in a 3D space, position information of each of the plurality of bones in the virtual space, and information on a current tracking state of each of the plurality of bones. As another example, the motion data may include coefficient values calculated for a plurality of points predefined for a face of a person based on a face blendshape scheme.

In operation 1250, the computer device 200 may generate a video in which avatars following the motions of the plurality of users are represented in the virtual space, based on the motion data. For example, the computer device 200 may generate the video by representing the avatars that follow the motions of the plurality of users on the received image.

In operation 1260, the computer device 200 may transmit the generated video to each of the terminals of the plurality of users through the communication session. An example of receiving, by the AMS 350, the data for the virtual space and the motion data of the users and generating and transmitting the video is described above through the screen sharing process 700 of FIG. 7.

Here, in operation 1240, the computer device 200 may receive the motion data from the terminals of the plurality of users in real time through the communication session using a real-time transmission protocol. In operation 1260, the computer device 200 may transmit the video generated based on the motion data to the terminals of the plurality of users in real time through the communication session using the real-time transmission protocol. Through this, the virtual space in which the avatars to which the motions of the participants of the communication session are applied in real time are represented may be shared between the participants in real time.

As described above, according to some example embodiments, it is possible to represent avatars of participants following motions of the participants including an owner on a virtual space of the owner and to share the virtual space with the participants in real time.

The systems and/or apparatuses described herein may be implemented using hardware components, software components, and/or a combination thereof. For example, the apparatuses and components described herein may be implemented using one or more general-purpose or special purpose computers, for example, a processor, a controller, an ALU, a digital signal processor, a microcomputer, an FPGA, a programmable logic unit (PLU), a microprocessor, or any other device capable of responding to and executing instructions in a defined manner. A processing device may run an OS and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, a computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include record media and storage media managed by an app store that distributes applications or a site, a server, and the like that supplies and distributes other various types of software.

The foregoing embodiments are merely examples and are not to be construed as limiting. The present disclosure be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A non-transitory computer-readable recording medium storing instructions that, when executed by a processor, cause the processor to:
set a communication session in which a plurality of users participate through a server;
generate data for a virtual space;
share motion data related to motions of the plurality of users through the communication session;
generate a video in which avatars following the motions of the plurality of users are represented in the virtual space, based on the motion data; and
share the generated video with the plurality of users through the communication session.

2. The non-transitory computer-readable recording medium of claim 1, wherein the instructions, when executed, cause the processor to generate the data for the virtual space by capturing an image input through a camera, and
wherein the instructions, when executed, cause the processor to generate the video by generating the video by representing the avatars following the motions of the plurality of users on the captured image.

3. The non-transitory computer-readable recording medium of claim 1, wherein the instructions, when executed, cause the processor to share of the motion data related to the motions of the plurality of users by receiving the motion data in real time through the communication session based on a real-time transmission protocol, and
wherein the instructions, when executed, cause the processor to share the generated video with the plurality of users by transmitting the generated video to terminals of the plurality of users in real time through the communication session based on the real-time transmission protocol.

4. The non-transitory computer-readable recording medium of claim 1, wherein the server is configured to route data transmitted between terminals of the plurality of users through the communication session.

5. The non-transitory computer-readable recording medium of claim 1, wherein the instructions, when executed, further cause the processor to:
share voices of the plurality of users through the communication session or another communication session set separate from the communication session.

6. The non-transitory computer-readable recording medium of claim 1, wherein the motion data comprises data related to at least one of poses and facial expressions of the plurality of users.

7. The non-transitory computer-readable recording medium of claim 1, wherein a pose of each of the avatars is configured to include a plurality of bones, and
wherein the motion data comprises an index of each of the plurality of bones, rotation information of each of the plurality of bones in a three-dimensional (3D) space, position information of each of the plurality of bones in the virtual space, and information on a current tracking state of each of the plurality of bones.

8. The non-transitory computer-readable recording medium of claim 1, wherein the motion data comprises coefficient values calculated for a plurality of points predefined for a face of a person based on a face blendshape scheme.

9. An avatar representation method comprising:
setting a communication session in which a plurality of users participate through a server;
generating data for a virtual space;
sharing motion data related to motions of the plurality of users through the communication session;
generating a video in which avatars following the motions of the plurality of users are represented in the virtual space, based on the motion data; and
sharing the generated video with the plurality of users through the communication session.

10. An avatar representation method comprising:
setting a communication session in which a plurality of users participate through a server;
receiving data for a virtual space from a terminal of a user among the plurality of users that is an owner of the virtual space;
receiving motion data related to motions of the plurality of users from terminals of the plurality of users through the communication session;
generating a video in which avatars following the motions of the plurality of users are represented in the virtual space, based on the motion data; and
transmitting the generated video to each of the terminals of the plurality of users through the communication session.

11. The avatar representation method of claim 10, wherein the receiving of the data for the virtual space comprises receiving, as the data for the virtual space, an image captured through a camera of the terminal of the user that is the owner of the virtual space, and
wherein the generating of the video comprises generating the video by representing the avatars following the motions of the plurality of users on the received image.

12. The avatar representation method of claim 10, wherein the receiving of the motion data comprises receiving the motion data from the terminals of the plurality of users in real time through the communication session based on a real-time transmission protocol, and
wherein the transmitting of the generated video comprises transmitting the video generated to the terminals of the plurality of users in real time through the communication session based on the real-time transmission protocol.

13. The avatar representation method of claim 10, further comprising:
routing data transmission between the terminals of the plurality of users through the communication session.

14. The avatar representation method of claim 10, further comprising:
mixing voices received from the plurality of users through the communication session or another communication session set separate from the communication session, and
providing the mixed voice to the plurality of users.

15. The avatar representation method of claim 10, wherein the motion data comprises data related to at least one of poses and facial expressions of the plurality of users.

16. A server comprising:
at least one memory storing instructions; and
at least one processor configured to execute the instructions to:
set a communication session in which a plurality of users participate;
generate data for a virtual space;
share motion data related to motions of the plurality of users through the communication session;
generate a video in which avatars following the motions of the plurality of users are represented in the virtual space, based on the motion data; and
share the generated video with the plurality of users through the communication session.

17. The server of claim 16, wherein the at least one processor is configured to execute the instructions to generate the data for the virtual space by capturing an image input through a camera, and
wherein the at least one processor is configured to execute the instructions to generate the video by generating the video by representing the avatars following the motions of the plurality of users on the captured image.

18. The server of claim 16, wherein the at least one processor is configured to execute the instructions to share of the motion data related to the motions of the plurality of users by receiving the motion data in real time through the communication session based on a real-time transmission protocol, and
wherein the at least one processor is configured to execute the instructions to share the generated video with the plurality of users by transmitting the generated video to terminals of the plurality of users in real time through the communication session based on the real-time transmission protocol.

19. The server of claim 16, wherein the at least one processor is configured to execute the instructions to route data transmitted between terminals of the plurality of users through the communication session.

20. The server of claim 16, wherein the at least one processor is further configured to execute the instructions to share voices of the plurality of users through the communication session or another communication session set separate from the communication session.
